(19) United States
(12) Patent Application Publication
(10) Pub. No.: US 2026/0204548 A1
(43) Pub. Date: Jul. 16, 2026

(54) BATTERY

(71) Applicant: ZHUHAI COSMX BATTERY CO., LTD., Zhuhai (CN)

(72) Inventors: Lu Liu, Zhuhai (CN); Peng Wang, Zhuhai (CN); Suli Li, Zhuhai (CN)

(21) Appl. No.: 19/136,284

(22) PCT Filed: Jan. 29, 2024
(86) PCT No.: PCT/CN2024/074381

§ 371 Date: Jun. 6, 2025

(30) Foreign Application Priority Data
Jan. 31, 2023 (CN) 202310048513.9

(51) Int. Cl. H01M 4/36; H01M 4/02; H01M 4/505; H01M 4/525; H01M 4/58; H01M 4/62

(52) U.S. Cl. CPC H01M 4/366; H01M 4/505; H01M 4/525; H01M 4/5825; H01M 4/625; H01M 2004/021; H01M 2004/028

(57) ABSTRACT

The present disclosure pertains to the field of batteries, and particularly relates to a battery. The battery comprises a positive electrode plate. The positive electrode plate comprises a positive current collector, a first active layer, and a second active layer. The first active layer is arranged on at least one side surface of the positive current collector, and the second active layer is arranged on an outer surface of the first active layer. After the battery is charged to 4.48V at 1.5C and discharged at 0.7C at 45° C. for 500 cycles, a ratio Ia=I(003)/I(104) of a peak intensity (003) to a peak intensity (104) in an X-ray diffraction spectrum of the first active layer and a ratio of Ib=I(003)/I(104) of a peak intensity (003) to a peak intensity (104) in an X-ray diffraction spectrum of the second active layer satisfy 0.5<Ib/Ia≤1.

### CROSS-REFERENCE TO RELATED PATENT APPLICATION

The present disclosure claims priority to Chinese Patent Application No. 202310048513.9, entitled “Battery”, filed with the China National Intellectual Property Administration on Jan. 31, 2023, the entire contents of which are incorporated herein by reference.

### FIELD

The present disclosure pertains to the field of batteries, and particularly relates to a battery.

### BACKGROUND

With the rapid development of the lithium-ion battery technology, lithium-ion batteries have been more and more widely applied in portable mobile electronic devices such as laptops and smart phones. To pursue a higher energy density, the charge upper limit voltage has also become increasingly higher. As the charge upper limit voltage continues to increase, the positive active material undergoes a series of phase transitions accompanied by a shear force, which disrupts the structural stability of the positive active material, and the positive electrode potential near the separator side is higher than that near the positive current collector side. As such, in the charging and discharging course, due to the polarization, the positive electrode overpotential near the separator side increases, and even irreversible phase transition may occur, which leaves severe cracks at the positive electrode, causes aggravated side reactions on the surface thereof, and further results in the loss of the positive active material, thereby seriously affecting performances of the battery, especially high-temperature performances, such as high-temperature cycling performance and high-temperature float charging performance.

Therefore, it is critically important to develop a battery that has a relatively high energy density without compromising electrochemical performances thereof.

### SUMMARY

It is an objective of the present disclosure to provide a battery to address the above problems existing in the prior art. The battery of the present disclosure can effectively inhibit the positive active material on the separator side from an irreversible phase transition, thereby reducing the energy loss of the positive active material.

In the first aspect, the present disclosure provides a battery, which comprises a positive electrode plate; the positive electrode plate comprises a positive current collector, a first active layer, and a second active layer; the first active layer is arranged on at least one side surface of the positive current collector, and the second active layer is arranged on an outer surface of the first active layer; after the battery is charged to 4.48V at 1.5C and discharged at 0.7C at 45° C. for 500 cycles, a ratio Ia=I(003)/I(104) of a peak intensity (003) to a peak intensity (104) in an X-ray diffraction spectrum of the first active layer and a ratio Ib=I(003)/I(104) of a peak intensity (003) to a peak intensity (104) in an X-ray diffraction spectrum of the second active layer satisfy 0.5<Ib/Ia≤1.

In the second aspect, the present disclosure provides a battery, which comprises a positive electrode plate; the positive electrode plate comprises a positive current collector, a first active layer, and a second active layer; the first active layer is arranged on at least one side surface of the positive current collector, and the second active layer is arranged on the outer surface of the first active layer; after the battery is charged to 4.48V at 1.5C and discharged at 0.7C at 45° C. for 500 cycles, a particle crushing percentage CPa of the first active layer and a particle crushing percentage CPb of the second active layer satisfy 1≤CPb/CPa≤2.

Through the above technical solutions, the present disclosure at least has the following advantages as compared with the prior art:
(1) the battery of the present disclosure can significantly reduce liquid phase overpotential on the separator side of the positive electrode plate, and further inhibit the positive active material on the separator side from an irreversible phase transition, thereby reducing the energy loss of the positive active material, especially significantly reducing the energy loss in the cycling and float charging course under high temperature and high voltage; wherein, the liquid phase overpotential refers to the potential at which ions migrate in the liquid phase;
(2) after it is charged to 4.48V at 1.5C and discharged at 0.7C at 45° C. for 500 cycles, the battery of the present disclosure satisfies 0.5<Ib (the ratio of peak intensity (003) to peak intensity (104) in the X-ray diffraction spectrum of the second active layer)/Ia (the ratio of peak intensity (003) to peak intensity (104) in the X-ray diffraction spectrum of the first active layer)≤1, which can effectively reduce the energy loss of the positive active material, especially significantly reduce the energy loss in the cycling and float charging course under high temperature and high voltage;
(3) after it is charged to 4.48V at 1.5C and discharged at 0.7C at 45° C. for 500 cycles, the battery of the present disclosure satisfies 1≤CPb (the particle crushing percentage of the second active layer)/CPa (the particle crushing percentage of the first active layer)≤2, which can effectively reduce the energy loss of the positive active material, especially significantly reduce the energy loss in the cycling and float charging course under high temperature and high voltage.

Endpoints of ranges and any values disclosed in this article are not limited to the exact ranges or values, and these ranges or values should be understood as including values close to these ranges or values. For numerical ranges, the endpoint values of each range, or the endpoint values of each range and individual point values, or individual point values can be combined with each other to obtain one or more new numerical ranges, which should be deemed to be specifically disclosed in this article.

### BRIEF DESCRIPTION OF THE DRAWINGS

FIG. 1 is a cross-sectional diagram of the positive electrode plate in one instance of the present disclosure;

FIG. 2 shows an XRD pattern of the positive electrode plate after 500 cycles of the battery prepared in Embodiment 1;

FIG. 3 is a diagram of comparison between XRD patterns of the positive electrode plates after 500 cycles of the batteries prepared in Embodiment 1 and Comparative Example 1;

FIG. 4 shows SEM images of the first active layer and the second active layer of the positive electrode plate after 500 cycles of the battery prepared in Embodiment 1, as well as SEM images of the first active layer of the positive electrode plate after 500 cycles of the battery prepared in Comparative Example 1.

### DETAILED DESCRIPTION

For the convenience of understanding the present disclosure, the present disclosure will be described below in more detail. However, it should be understood that the present disclosure can be implemented in many different forms, and is not confined to the manners of implementation or embodiments described in this article. On the contrary, the purpose of providing these manners of implementation or embodiments is to make the understanding of the disclosed contents of the present disclosure more thorough and more comprehensive.

Unless otherwise defined, all the technical and scientific terms used in this article have the same meanings as those commonly understood by those skilled in the art to which the present disclosure belongs. The terms used in the specification of the present disclosure are only for the purpose of describing specific manners of implementation or embodiments, and are not intended to limit the present disclosure.

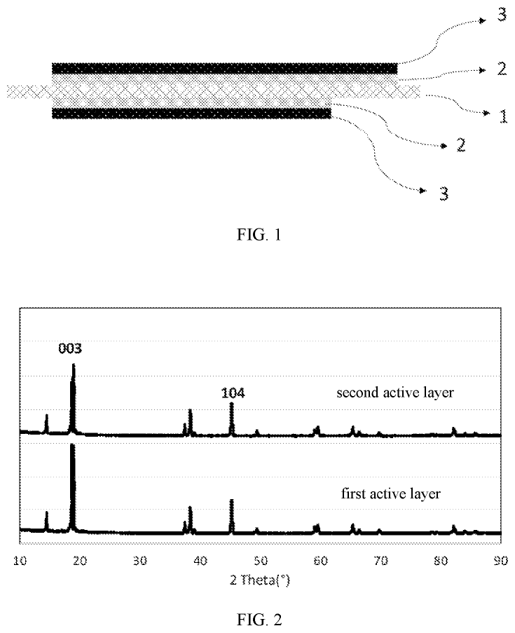

In the first aspect, the present disclosure provides a battery, which comprises a positive electrode plate; the positive electrode plate can comprise a positive current collector, a first active layer, and a second active layer; the first active layer can be arranged on at least one side surface of the positive current collector, and the second active layer is arranged on an outer surface of the first active layer. FIG. 1 is a cross-sectional diagram of the positive electrode plate in one instance of the present disclosure. In FIG. 1, the positive electrode plate comprises a positive current collector 1, a first active layer 2, and a second active layer 3, the first active layer 2 is arranged on both side surfaces of the positive current collector 1, and the second active layer 3 is arranged on an outer surface of the first active layer 2.

In the present disclosure, the outer surface of the first active layer refers to a surface on one side of the first active layer, which side is distal from the positive current collector.

After the battery is charged to 4.48V at 1.5C and discharged at 0.7C at 45° C. for 500 cycles, there are a ratio of peak intensity (003) to peak intensity (104) in the X-ray diffraction spectrum of the first active layer, Ia=I(003)/I(104), and a ratio of peak intensity (003) to peak intensity (104) in the X-ray diffraction spectrum of the second active layer, Ib=I(003)/I(104), which satisfy 0.5<Ib/Ia≤1, e.g., Ib/Ia=0.51, 0.55, 0.6, 0.65, 0.7, 0.75, 0.8, 0.85, 0.9, 0.95, or 1.

In the present disclosure, the diffraction peak 003 and the diffraction peak 004 are diffraction peaks of lithium cobalt oxide. FIG. 2 shows an XRD pattern of the first active layer and the second active layer of the positive electrode plate after 500 cycles of the battery in a specific manner of implementation of the present disclosure;

In the present disclosure, 1≤Ia≤3, e.g., Ia=1, 1.1, 1.2, 1.3, 1.34, 1.4, 1.5, 1.6, 1.7, 1.8, 1.9, 1.97, 2, 2.1, 2.13, 2.2, 2.3, 2.4, 2.47, 2.5, 2.58, 2.6, 2.7, 2.8, 2.9 or 3; 0.5≤Ib≤3, e.g., Ib=0.5, 0.6, 0.7, 0.71, 0.8, 0.9, 1, 1.1, 1.2, 1.3, 1.4, 1.5, 1.6, 1.68, 1.7, 1.8, 1.9, 1.97, 2, 2.1, 2.2, 2.3, 2.35, 2.4, 2.5, 2.57, 2.6, 2.7, 2.8, 2.9 or 3.

In one instance, 1.34≤Ia≤2.58, 0.71≤Ib≤2.57. When Ia and Ib respectively fall within the above ranges, the irreversible phase transition of the positive active material in the first active layer and the second active layer is inhibited, and the energy loss of the positive active material can be effectively ameliorated, so as to improve the electrochemical performances of the battery.

To pursue a higher energy density, the charge upper limit voltage of a battery becomes increasingly higher, which leads to a progressive increase in the energy loss of the positive active material. Taking lithium cobalt oxide (LiCoO₂) positive active material as an example, when a high voltage system, especially the charging voltage, exceeds 4.48V, the average electrode potential on the positive electrode side generally exceeds 4.55V; at this time, lithium cobalt oxide will undergo an irreversible phase transition, i.e., a transition from the phase O3 to the phase H1-3, as well as a shear force on the CoO₂ layer, which accompanies the transition from the phase O3 to the phase H1-3, disrupts the structural stability of lithium cobalt oxide; moreover, the positive electrode potential near the separator side is higher than that near the positive current collector side; as such, in the charging and discharging course, due to the polarization, the positive electrode overpotential near the separator side increases, and even 01 phase transition may occur; the phase transition is irreversible, leaves severe cracks at the positive electrode, causes aggravated side reactions on the surface thereof, and further results in the energy loss of the positive active material, thereby seriously affecting performances of the battery. The inventor of the present disclosure has found that: two active material layers are arranged to be stacked in sequence on the outer surface on at least one side of the positive current collector, and after the battery is charged to 4.48V at 1.5C and discharged at 0.7C at 45° C. for 500 cycles, there are a ratio of peak intensity (003) to peak intensity (104) in the X-ray diffraction spectrum of the active material layer on the inner layer, Ia=I(003)/I(104), and a ratio of peak intensity (003) to peak intensity (104) in the X-ray diffraction spectrum of the active layer on the outer layer, Ib=I(003)/I(104); when 0.5<Ib/Ia≤1 is satisfied, the impedance of the positive electrode plate can be significantly reduced on the premise of ensuring the energy density of the battery; further, the potential of the positive electrode plate is decreased, and the positive active material is inhibited from an irreversible phase transition, so as to effectively ameliorate the energy loss of the positive active material and ensure the electrochemical performances of the battery.

In the present disclosure, the ratio of the impedance of the first active layer to that of the second active layer can be greater than or equal to 1.1, e.g., 1.1, 1.2, 1.3, 1.4, 1.5, 2, 5, 10, 15, 20, 25, 30, 35, 40, 45, 50, 55, 60, 65, 70, 75, 80, 85, 90, 95, 100, 200, 500, 1000, 1500, or 2000.

In one instance, the ratio of the impedance of the first active layer to that of the second active layer is 1.5-1000.

In one instance, the ratio of the impedance of the first active layer to that of the second active layer is 1.5-10.

In the present disclosure, the impedance of the first active layer and that of the second active layer can be tested in the following method, which specifically comprises:
coating the first active layer and the second active layer on one side surface of the aluminum foil, respectively; obtaining an electrode plate A coated with the first active layer and an electrode plate B coated with the second active layer; assembling the electrode plate A and the electrode plate B as obtained into a coin-type half cell A′ and a coin-type half cell B′, respectively (wherein the positive electrode plate is the electrode plate A and the electrode plate B, and the negative electrode plate is lithium foil); using an electrochemical workstation to measure EIS spectra (electrochemical impedance spectra) of the cell A′ and the cell B′, with a frequency range of 0.01 Hz-1 MHz; accordingly, obtaining the impedance of the first active layer and the impedance of the second active layer.
the first active layer can comprise a first conductive agent, and the second active layer can comprise a second conductive agent.

The inventor of the present disclosure has found that the first conductive agent and the second conductive agent have such a particular content that the ratio of the impedance of the first active layer to that of the second active layer is greater than or equal to 1.1.

Based on the total weight of the first active layer, the first conductive agent can have a content of 0.5-5% by weight (e.g., 0.5, 1, 1.5, 2, 2.5, 3, 3.5, 4, 4.5, or 5% by weight); based on the total weight of the second active layer, the second conductive agent can have a content of 1-40% by weight (e.g., 1, 2, 3, 4, 5, 6, 7, 8, 9, 10, 15, 20, 25, 30, 35, or 40% by weight).

In one instance, based on the total weight of the first active layer, the first conductive agent has a content of 0.8-4% by weight; based on the total weight of the second active layer, the second conductive agent has a content of 1.1-20% by weight.

In one instance, based on the total weight of the first active layer, the first conductive agent has a content of 1-1.5% by weight; based on the total weight of the second active layer, the second conductive agent has a content of 2.6-4.1% by weight.

The first active layer can further comprise a first active material and a first binding agent. Based on the total weight of the first active layer, the first active material can have a content of 90-99% by weight (e.g., 90, 91, 92, 93, 94, 95, 96, 97, 98 or 99% by weight), and the first binding agent can have a content of 0.5-5% by weight (e.g., 5, 4.5, 4, 3.5, 3, 2.5, 2, 1.5, 1 or 0.5% by weight).

In one instance, based on the total weight of the first active layer, the first active material has a content of 92-98.4% by weight, and the first binding agent has a content of 0.8-4% by weight.

In one instance, based on the total weight of the first active layer, the first active material has a content of 95-98% by weight, and the first binding agent has a content of 1-3.5% by weight.

The second active layer can further comprise a second active material and a second binding agent. Based on the total weight of the second active layer, the second active material can have a content of 60-98.5% by weight (e.g., 60, 65, 70, 75, 80, 85, 90, 95 or 98.5% by weight), and the second binding agent can have a content of 0.5-5% by weight (e.g., 5, 4.5, 4, 3.5, 3, 2.5, 2, 1.5, 1 or 0.5% by weight).

In one instance, based on the total weight of the second active layer, the second active material has a content of 76-98% by weight, and the second binding agent has a content of 0.8-4% by weight.

In one instance, based on the total weight of the second active layer, the second active material has a content of 93-96% by weight, and the second binding agent has a content of 1.4-2.9% by weight.

The first conductive agent and the second conductive agent can each be independently selected from conventional conductive agents in the art, e.g., they can be at least one selected from conductive carbon black, acetylene black, Ketjen black, conductive graphite, conductive carbon fiber, carbon nanotubes, metal powder, and carbon fiber.

The inventor of the present disclosure has found that when the conductive performance of the second conductive agent is superior to that of the first conductive agent, the impedance of the first active layer is greater than that of the second active layer, and when the second active layer comprises a particular content of carbon nanotubes, the positive electrode plate has a relatively low impedance.

In one instance, the first conductive agent comprises conductive carbon black, and the second conductive agent comprises carbon nanotubes.

The mass of the carbon nanotubes can account for 45%-65% of the total mass of the second conductive agent, e.g., 45%, 46%, 47%, 48%, 49%, 50%, 51%, 52%, 53%, 54%, 55%, 56%, 57%, 58%, 59%, 60%, 61%, 62%, 63%, 64% or 65%.

In one instance, the mass of the carbon nanotubes accounts for 55%-60% of the total mass of the second conductive agent.

The first active material and the second active material can comprise lithium cobalt oxide.

In one instance, the first active material and the second active material are each independently a combination of lithium cobalt oxide and other positive active materials. The other positive active materials can be selected from conventional positive active materials in the art, e.g., they include at least one of nickel cobalt manganese oxide, lithium manganese oxide, lithium nickel manganese oxide, lithium nickel cobalt aluminum oxide, lithium nickel oxide, lithium nickel cobalt manganese aluminum oxide, and lithium iron phosphate.

In one instance, the first active material is lithium cobalt oxide, and the second active material is lithium cobalt oxide.

The first binding agent and the second binding agent can each be independently selected from binding agents commonly used in the art, e.g., they can be at least one of styrene-butadiene rubber, polyacrylic acid, polyacrylate, sodium polyacrylate, polyvinylidene fluoride, polytetrafluoroethylene, and lithium polyacrylate.

In general, the energy density of a battery is determined by the content of active materials in the active coating. In the present disclosure, the energy density of the battery is determined by both the content of the first active material in the first active layer and that of the second active material in the second active layer. It can be understood that the higher the content of the conductive agent in the second active layer and the greater the thickness of the second active layer, the lower the impedance of the positive electrode plate, and further, the lower the potential of the positive electrode plate and the more stable the battery; however, as the content of conductive agent in the second active layer rises and the thickness of the second active layer increases, the energy density of the battery decreases accordingly. Therefore, in the specific implementation course, the appropriate content of the conductive agent in the second active layer and the appropriate thickness of the second active layer can be selected according to different needs of the battery.

The ratio of the thickness of the first active layer to that of the second active layer can be (0.2-10):1, e.g., 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1, or 10:1.

In one instance, the ratio of the thickness of the first active layer to that of the second active layer is (0.5-3):1.

The first active layer can have a thickness of 10-150 μm, e.g., 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, or 150 μm.

The second active layer can have a thickness of 10-150 μm, e.g., 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, or 150 μm.

In addition to the positive electrode plate, the components of the battery (e.g., a negative electrode plate, a separator, and an electrolyte) can all be conventional selections in the art.

In one instance, the battery further comprises a negative electrode plate, a separator, and an electrolyte.

The negative electrode plate can comprise a negative current collector and a negative active layer that is arranged on at least one side surface of the negative current collector, and the negative active layer can comprise a negative active material.

The negative active material can be a conventional selection in the art. For example, the negative active material is at least one selected from graphite, carbon nanotubes, graphene, carbon black, silicon carbon, silicon, and silicon oxygen.

The assembly of the battery can be carried out in a conventional manner in the art.

The battery can be a liquid electrolyte battery.

In the present disclosure, after the battery is charged to 4.48V at 1.5C and discharge at 0.7C at 45° C. for 500 cycles, the positive electrode potential thereof is ≤4.550V, e.g., the positive electrode potential is 4.550V, 4.548V, 4.538V, 4.525V, or 4.517V.

In the present disclosure, after the battery is charged to 4.48V at 1.5C and discharge at 0.7C at 45° C. for 500 cycles, the positive electrode impedance thereof is ≤10702, e.g., the positive electrode impedance is 1072, 942, 852, 772, or 692.

The positive electrode plate of the battery in the present disclosure has a relatively low impedance, which can reduce the potential of the positive electrode plate, and further reduce the liquid phase overpotential on the separator side of the positive electrode plate and inhibit the positive active material from an irreversible phase transition, thereby effectively ameliorating the energy loss of the positive active material in the cycling course and ensuring the electrochemical performances of the battery.

In the second aspect, the present application provides a battery, which can comprise a positive electrode plate; the positive electrode plate can comprise a positive current collector, a first active layer, and a second active layer; the first active layer can be arranged on at least one side surface of the positive current collector, and the second active layer can be arranged on an outer surface of the first active layer. FIG. 1 is a cross-sectional diagram of the positive electrode plate in one instance of the present disclosure. In FIG. 1, the positive electrode plate comprises a positive current collector 1, a first active layer 2, and a second active layer 3, the first active layer 2 is arranged on both side surfaces of the positive current collector 1, and the second active layer 3 is arranged on an outer surface of the first active layer 2.

In the present disclosure, the outer surface of the first active layer refers to a surface on one side of the first active layer, which side is distal from the positive current collector.

After the battery is charged to 4.48V at 1.5C and discharge at 0.7C at 45° C. for 500 cycles, the first active layer has a particle crushing percentage CPa, and the second active layer has a particle crushing percentage CPb, which satisfy 1≤CPb/CPa≤2, e.g., CPb/CPa=1, 1.1, 1.2, 1.3, 1.4, 1.5, 1.6, 1.7, 1.8, 1.9, or 2.

In the present disclosure, the particle crushing percentage CPa of the first active layer and the particle crushing percentage CPb of the second active layer can be tested by using an argon ion beam cross-section polisher coupled with a scanning electron microscope (CP-SEM), wherein the specific calculation method of the particle crushing percentage is as follows: selecting particles with a size of 10 μm or more in the field of view, wherein the ratio of the number of particles with cracks to the total number of particles with a size of 10 μm or more is the particle crushing percentage at the positive electrode. FIG. 4 shows SEM images of the first active layer and the second active layer of the positive electrode plate after 500 cycles of the battery in one specific manner of implementation of the present disclosure, as well as SEM images of the first active layer of the positive electrode plate after 500 cycles of the battery in one specific comparative example.

In the present disclosure, 5%≤CPa≤40%, e.g., CPa=5%, 5.3%, 7.3%, 10%, 12.5%, 15%, 16.7%, 20%, 25%, 30%, 35%, 36%, or 40%; 5%≤CPb≤60%, e.g., CPb=5%, 6%, 8%, 10%, 15%, 15.6%, 20%, 21.3%, 25%, 30%, 35%, 40%, 45%, 50%, 55%, 59% or 60%.

In one instance, 5.3%≤CPa≤36%, 5.7%≤CPb≤59%. When CPa and CPb fall within the above ranges, the degree of the disruption to the structural stability of the positive active material in the first active layer and the second active layer can be limited, and the irreversible phase transition of the positive active material can be inhibited, so as to ameliorate the energy loss of the positive active material and improve the electrochemical performances of the battery.

To pursue a higher energy density, the charge upper limit voltage of a battery becomes increasingly higher, which leads to a progressive increase in the energy loss of the positive active material. Taking lithium cobalt oxide (LiCoO₂) positive active material as an example, when a high voltage system, especially the charging voltage, exceeds 4.48V, the average electrode potential on the positive electrode side generally exceeds 4.55V; at this time, lithium cobalt oxide will undergo an irreversible phase transition, i.e., a transition from the phase O3 to the phase H1-3, as well as a shear force on the CoO₂ layer, which accompanies the transition from the phase O3 to the phase H1-3, disrupts the structural stability of lithium cobalt oxide; moreover, the positive electrode potential near the separator side is higher than that near the positive current collector side; as such, in the charging and discharging course, due to the polarization, the positive electrode overpotential near the separator side increases, and even O1 phase transition may occur; the phase transition is irreversible, leaves severe cracks at the positive electrode, causes aggravated side reactions on the surface thereof, and further results in the energy loss of the positive active material, thereby seriously affecting performances of the battery. The inventor of the present disclosure has found that: two active material layers are arranged to be stacked in sequence on the outer surface on at least one side of the positive current collector, and after the battery is charged to 4.48V at 1.5C and discharged at 0.7C at 45° C. for 500 cycles, when the particle crushing percentage CPa of the active material layer on the inner layer and the particle crushing percentage CPb of the active material layer on the outer layer satisfy 1≤CPb/CPa≤2, the impedance of the positive electrode plate can be significantly reduced on the premise of ensuring the energy density of the battery; further, the potential of the positive electrode plate can be reduced, and the positive active material can be inhibited from an irreversible phase transition, so as to effectively ameliorate the energy loss of the positive active material and ensure the electrochemical performances of the battery.

In the present disclosure, the ratio of the impedance of the first active layer to that of the second active layer is greater than or equal to 1.1, e.g., 1.1, 1.2, 1.3, 1.4, 1.5, 2, 5, 10, 15, 20, 25, 30, 35, 40, 45, 50, 55, 60, 65, 70, 75, 80, 85, 90, 95, 100, 200, 500, 1000, 1500, or 2000.

In one instance, the ratio of the impedance of the first active layer to that of the second active layer is 1.5-1000.

In one instance, the ratio of the impedance of the first active layer to that of the second active layer is 1.5-10.

In the present disclosure, the impedance of the first active layer and that of the second active layer can be tested in the following method, which specifically comprises:
coating the first active layer and the second active layer on one side surface of the aluminum foil, respectively; obtaining a plate A coated with the first active layer and a plate B coated with the second active layer; assembling the plate A and the plate B as obtained into a coin-type half cell A′ and a coin-type half cell B′, respectively (wherein the positive electrode plate is the plate A and the plate B, and the negative electrode plate is the lithium foil); using an electrochemical workstation to measure EIS spectra (electrochemical impedance spectra) of the cell A′ and the cell B′, with a frequency range of 0.01 Hz-1 MHz; accordingly, obtaining the impedance of the first active layer and the impedance of the second active layer.
the first active layer can comprise a first conductive agent, and the second active layer can comprise a second conductive agent.

The inventor of the present disclosure has found that the first conductive agent and the second conductive agent have such a particular content that the ratio of the impedance of the first active layer to that of the second active layer is greater than or equal to 1.1.

Based on the total weight of the first active layer, the first conductive agent can have a content of 0.5-5% by weight (e.g., 0.5, 1, 1.5, 2, 2.5, 3, 3.5, 4, 4.5, or 5% by weight); based on the total weight of the second active layer, the second conductive agent can have a content of 1-40% by weight (e.g., 1, 2, 3, 4, 5, 6, 7, 8, 9, 10, 15, 20, 25, 30, 35, or 40% by weight).

In one instance, based on the total weight of the first active layer, the first conductive agent has a content of 0.8-4% by weight; based on the total weight of the second active layer, the second conductive agent has a content of 1.1-20% by weight.

In one instance, based on the total weight of the first active layer, the first conductive agent has a content of 1-1.5% by weight; based on the total weight of the second active layer, the second conductive agent has a content of 2.6-4.1% by weight.

The first active layer can further comprise a first active material and a first binding agent. Based on the total weight of the first active layer, the first active material can have a content of 90-99% by weight (e.g., 90, 91, 92, 93, 94, 95, 96, 97, 98 or 99% by weight), and the first binding agent can have a content of 0.5-5% by weight (e.g., 5, 4.5, 4, 3.5, 3, 2.5, 2, 1.5, 1 or 0.5% by weight).

In one instance, based on the total weight of the first active layer, the first active material has a content of 92-98.4% by weight, and the first binding agent has a content of 0.8-4% by weight.

In one instance, based on the total weight of the first active layer, the first active material has a content of 95-98% by weight, and the first binding agent has a content of 1-3.5% by weight.

The second active layer can further comprise a second active material and a second binding agent. Based on the total weight of the second active layer, the second active material can have a content of 60-98.5% by weight (e.g., 60, 65, 70, 75, 80, 85, 90, 95 or 98.5% by weight), and the second binding agent can have a content of 0.5-5% by weight (e.g., 5, 4.5, 4, 3.5, 3, 2.5, 2, 1.5, 1 or 0.5% by weight).

In one instance, based on the total weight of the second active layer, the second active material has a content of 76-98% by weight, and the second binding agent has a content of 0.8-4% by weight.

In one instance, based on the total weight of the second active layer, the second active material has a content of 93-96% by weight, and the second binding agent has a content of 1.4-2.9% by weight.

The first conductive agent and the second conductive agent can each be independently selected from conventional conductive agents in the art, e.g., they can be at least one selected from conductive carbon black, acetylene black, Ketjen black, conductive graphite, conductive carbon fiber, carbon nanotubes, metal powder, and carbon fiber.

The inventor of the present disclosure has found that when the conductive performance of the second conductive agent is superior to that of the first conductive agent, the impedance of the first active layer is greater than that of the second active layer, and when the second active layer comprises a particular content of carbon nanotubes, the positive electrode plate has a relatively low impedance.

In one instance, the first conductive agent comprises conductive carbon black, and the second conductive agent comprises carbon nanotubes.

The mass of the carbon nanotubes can account for 45%-65% of the total mass of the second conductive agent, e.g., 45%, 46%, 47%, 48%, 49%, 50%, 51%, 52%, 53%, 54%, 55%, 56%, 57%, 58%, 59%, 60%, 61%, 62%, 63%, 64% or 65%.

In one instance, the mass of the carbon nanotubes accounts for 55%-60% of the total mass of the second conductive agent.

The first active material and the second active material can each be independently selected from positive active materials commonly used in the art, e.g., they are at least one selected from lithium cobalt oxide, lithium nickel cobalt manganese oxide, lithium manganese oxide, lithium nickel manganese oxide, lithium nickel cobalt aluminum oxide, lithium nickel oxide, lithium nickel cobalt manganese aluminum oxide, and lithium iron phosphate.

In one instance, the first active material is lithium cobalt oxide, and the second active material is lithium cobalt oxide.

The first binding agent and the second binding agent can each be independently selected from binding agents commonly used in the art, e.g., they can be at least one of styrene-butadiene rubber, polyacrylic acid, polyacrylate, sodium polyacrylate, polyvinylidene fluoride, polytetrafluoroethylene, and lithium polyacrylate.

In general, the energy density of a battery is determined by the content of active materials in the active coating. In the present disclosure, the energy density of the battery is determined by both the content of the first active material in the first active layer and that of the second active material in the second active layer. It can be understood that the higher the content of the conductive agent in the second active layer and the greater the thickness of the second active layer, the lower the impedance of the positive electrode plate, and further, the lower the potential of the positive electrode plate and the more stable the battery; however, as the content of conductive agent in the second active layer rises and the thickness of the second active layer increases, the energy density of the battery decreases accordingly. Therefore, in the specific implementation course, the appropriate content of the conductive agent in the second active layer and the appropriate thickness of the second active layer can be selected according to different needs of the battery.

The ratio of the thickness of the first active layer to that of the second active layer can be (0.2-10):1, e.g., 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1, or 10:1. When the ratio of the thickness of the first active layer to that of the second active layer falls within the above range, the low impedance of the positive electrode plate and the high energy density of the battery can be achieved simultaneously.

In one instance, the ratio of the thickness of the first active layer to that of the second active layer is (0.5-3):1.

The first active layer can have a thickness of 10-150 μm, e.g., 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, or 150 μm.

The second active layer can have a thickness of 10-150 μm, e.g., 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, or 150 μm.

In addition to the positive electrode plate, the components of the battery (e.g., a negative electrode plate, a separator, and an electrolyte) can all be conventional selections in the art.

In one instance, the battery further comprises a negative electrode plate, a separator, and an electrolyte.

The negative electrode plate can comprise a negative current collector and a negative active layer that is arranged on at least one side surface of the negative current collector, and the negative active layer can comprise a negative active material.

The negative active material can be a conventional selection in the art, e.g., the negative active material is at least one selected from graphite, carbon nanotubes, graphene, carbon black, silicon, silicon carbon, and silicon oxygen.

The assembly of the battery can be carried out in a conventional manner in the art.

The battery can be any one of a liquid electrolyte battery, a gel electrolyte battery, and a solid electrolyte battery.

In the present disclosure, after the battery is charged to 4.48V at 1.5C and discharge at 0.7C at 45° C. for 500 cycles, the positive electrode potential thereof is ≤4.550V, e.g., the positive electrode potential is 4.550V, 4.548V, 4.538V, 4.525V, or 4.517V.

In the present disclosure, after the battery is charged to 4.48V at 1.5C and discharged at 0.7C at 45° C. for 500 cycles, the positive electrode impedance thereof is ≤10722, e.g., the positive electrode impedance is 10762, 942, 852, 772, or 692.

The positive electrode plate of the battery in the present disclosure has a relatively low impedance, which can reduce the potential of the positive electrode plate, and further reduce the liquid phase overpotential on the separator side of the positive electrode plate and inhibit the positive active material from an irreversible phase transition, thereby effectively ameliorating the energy loss of the positive active material in the cycling course and ensuring the electrochemical performances of the battery.

The present disclosure will be described below in detail through embodiments. The embodiments described in the present disclosure are merely some embodiments of the present disclosure, rather than all the embodiments. All other embodiments obtained by persons skilled in the art based on the embodiments of the present disclosure without creative efforts fall with the scope of protection of the present disclosure.

Unless otherwise specified, all materials used in the following embodiments are commercially available analytical-grade ones.

The following embodiments serve to illustrate the battery of the present disclosure.

### Embodiment 1

The battery is prepared in the following steps:
(1) preparation of a positive electrode first active layer slurry:
adding lithium cobalt oxide, conductive carbon black, and polyvinylidene fluoride in a mass ratio of 97.8:1.1:1.1 into a stirred tank, adding N-methylpyrrolidone, and fabricating them into the positive electrode first active layer slurry, with a solid content of 78 wt %;
(2) preparation of a positive electrode second active layer slurry:
adding lithium cobalt oxide, conductive carbon black, carbon nanotubes, and polyvinylidene fluoride into a stirred tank in a mass ratio of 95.4:1.1:1.5:2, adding N-methylpyrrolidone, and fabricating them into the positive electrode second active layer slurry, with a solid content of 78 wt %;
(3) preparation of a positive electrode plate:
applying the positive electrode first active layer slurry prepared in Step (1) on both side surfaces of aluminum foil by using a coating machine, and drying; applying the positive electrode second active layer slurry prepared in Step (2) on the surface of the dried first active layer, and after drying and cutting, obtaining the positive electrode plate;
(4) preparation of a negative electrode plate:
adding graphite, conductive carbon black, sodium carboxymethylcellulose, and styrene-butadiene rubber latex in a mass ratio of 95.9:1.5:1.3:1.3 into a stirred tank, adding deionized water, and fabricating them into a negative active layer slurry, with a solid content of 50 wt %; applying the negative active layer slurry on both side surfaces of copper foil by using a coating machine, and after drying and cutting, obtaining the negative electrode plate;
(5) preparation of a battery:
winding the positive electrode plate obtained in Step (3), the negative electrode plate obtained in Step (4), and a separator (a polyethylene film) to form a jelly roll, packaging the jelly roll with an aluminum-plastic film, removing moisture by baking, injecting an electrolyte, and obtaining the battery by using the hot-pressing formation process.

Embodiments 2-7 and Comparative Examples 1-6 were carried out with reference to Embodiment 1, and the differences lie in the composition and ratio of the positive electrode first active layer, the composition and ratio of the positive electrode second active layer, the thickness of the positive electrode first active layer, and the thickness of the positive electrode second active layer, as shown in Table 1.

TABLE 1

| | | | | | Impedance |
|---|---|---|---|---|---|
| | | | | | ratio of the |
| | | | | | positive |
| | | | | | electrode |
| | Composition | Composition | Thickness | Thickness | first active |
| | and ratio of | and ratio of | of the | of the | layer to the |
| | the positive | the positive | positive | positive | positive |
| | electrode | electrode | electrode | electrode | electrode |
| | first active | second active | first active | second active | second active |
| | layer | layer | layer/μm | layer/μm | layer |
| Embodiment | Lithium cobalt | Lithium cobalt | 34 | 68 | 2.73 |
| 1 | oxide:Conductive | oxide:Conductive | | | |
| | carbon | carbon | | | |
| | black:Polyvinylidene | black:Carbon | | | |
| | fluoride = | nanotubes:Polyvinylidene | | | |
| | 97.8:1.1:1.1 | fluoride = | | | |
| | | 95.4:1.1:1.5:2 | | | |
| Embodiment | Lithium cobalt | Lithium cobalt | 34 | 68 | 2.14 |
| 2 | oxide:Conductive | oxide:Conductive | | | |
| | carbon | carbon | | | |
| | black:Polyvinylidene | black:Polyvinylidene | | | |
| | fluoride = | fluoride = | | | |
| | 97.8:1.1:1.1 | 93.4:4.1:2.5 | | | |
| Embodiment | Lithium cobalt | Lithium cobalt | 34 | 68 | 1.77 |
| 3 | oxide:Conductive | oxide:Conductive | | | |
| | carbon | carbon | | | |
| | black:Polyvinylidene | black:Carbon | | | |
| | fluoride = | nanotubes:Polyvinylidene | | | |
| | 97.8:1.1:1.1 | fluoride = | | | |
| | | 96.8:0.6:1:1.6 | | | |
| Embodiment | Lithium cobalt | Lithium cobalt | 34 | 68 | 1.46 |
| 4 | oxide:Conductive | oxide:Conductive | | | |
| | carbon | carbon | | | |
| | black:Polyvinylidene | black:Polyvinylidene | | | |
| | fluoride = | fluoride = | | | |
| | 97.8:1.1:1.1 | 96:2:2 | | | |
| Embodiment | Lithium cobalt | Lithium cobalt | 34 | 68 | 1.18 |
| 5 | oxide:Conductive | oxide:Conductive | | | |
| | carbon | carbon | | | |
| | black:Polyvinylidene | black:carbon | | | |
| | fluoride = | nanotubes:polyvinylidene | | | |
| | 97.8:1.1:1.1 | fluoride = | | | |
| | | 97.8:0.6:0.5:1.1 | | | |
| Embodiment | Lithium cobalt | Lithium cobalt | 34 | 68 | 0.7 |
| 6 | oxide:Conductive | oxide:Conductive | | | |
| | carbon | carbon | | | |
| | black:Polyvinylidene | black:Polyvinylidene | | | |
| | fluoride = | fluoride = | | | |
| | 97.8:1.1:1.1 | 98.4:0.5:1.1 | | | |
| Embodiment | Lithium cobalt | Lithium cobalt | 34 | 68 | 5.3 |
| 7 | oxide:Conductive | oxide:Conductive | | | |
| | carbon | carbon | | | |
| | black:Polyvinylidene | black:Polyvinylidene | | | |
| | fluoride = | fluoride = | | | |
| | 97.8:1.1:1.1 | 88:10:2 | | | |
| Comparative | Lithium cobalt | / | 102 | / | / |
| Example 1 | oxide:Conductive | | | | |
| | carbon | | | | |
| | black:Polyvinylidene | | | | |
| | fluoride = | | | | |
| | 97.8:1.1:1.1 | | | | |
| Comparative | Lithium cobalt | / | 102 | / | / |
| Example 2 | oxide:Conductive | | | | |
| | carbon | | | | |
| | black:Polyvinylidene | | | | |
| | fluoride = | | | | |
| | 93.4:4.1:2.5 | | | | |
| Comparative | Lithium cobalt | / | 102 | / | / |
| Example 3 | oxide:Conductive | | | | |
| | carbon | | | | |
| | black:Carbon | | | | |
| | nanotubes:Polyvinylidene | | | | |
| | fluoride = | | | | |
| | 97.8:0.6:0.5:1.1 | | | | |
| Comparative | Lithium cobalt | / | 102 | / | / |
| Example 4 | oxide:Conductive | | | | |
| | carbon | | | | |
| | black:Polyvinylidene | | | | |
| | fluoride = | | | | |
| | 98.4:0.5:1.1 | | | | |
| Comparative | Lithium cobalt | Lithium cobalt | 34 | 68 | 0.4 |
| Example 5 | oxide:Conductive | oxide:Conductive | | | |
| | carbon | carbon | | | |
| | black:Polyvinylidene | black:Polyvinylidene | | | |
| | fluoride = | fluoride = | | | |
| | 97.8:1.1:1.1 | 98.6:0.3:1.1 | | | |
| Comparative | Lithium cobalt | Lithium cobalt | 34 | 68 | 0.5 |
| Example 6 | oxide:Conductive | oxide:Conductive | | | |
| | carbon | carbon | | | |
| | black:Carbon | black:Polyvinylidene | | | |
| | nanotubes:Polyvinylidene | fluoride = | | | |
| | fluoride = | 98.6:0.3:1.1 | | | |
| | 97.8:0.6:0.5:1.1 | | | | |

### Test Embodiments

### (1) Positive Electrode Potential Test

The positive electrode plates prepared in the embodiments and the comparative examples (the positive electrode plates obtained in the embodiments and the comparative examples share a compacted density of 4.15 g/cm³) were assembled into pouch-type three-electrode cells; the cells were charged at 1.5C to the upper limit voltage of 4.48V and discharged at 0.7C at 45° C.; the charge was repeated in the same way for 500 cycles to obtain the positive electrode potential. The results are recorded in Table 2.

### (2) Positive Electrode Impedance Test

The positive electrode plates prepared in the embodiments and the comparative examples were assembled into coin-type half cells, respectively; wherein, the negative electrode plate was lithium foil; an electrochemical workstation was used to measure the EIS spectra (electrochemical impedance spectra) of the coin-type half cells, with a frequency range of 0.01 Hz-1 MHz. The results are recorded in Table 2.

### (3) Positive Material Loss Test

The batteries prepared in the embodiments and the comparative examples were charged at 0.1C to 4.53V and discharged at 0.1C to 3.0V for 3 cycles; the discharge capacity in the third cycle was divided by the mass of the active material of the positive electrode plate to obtain the gravimetric capacity of the positive material. The results are recorded in Table 2.

### (4) Energy Density Test

The thickness, width, and length of the batteries prepared in the embodiments and the comparative examples were measured by using a caliper or a thickness gauge. Energy density=capacity*platform voltage/(cell thickness*cell width*cell length). The results are recorded in Table 2.

### (5) XRD Test

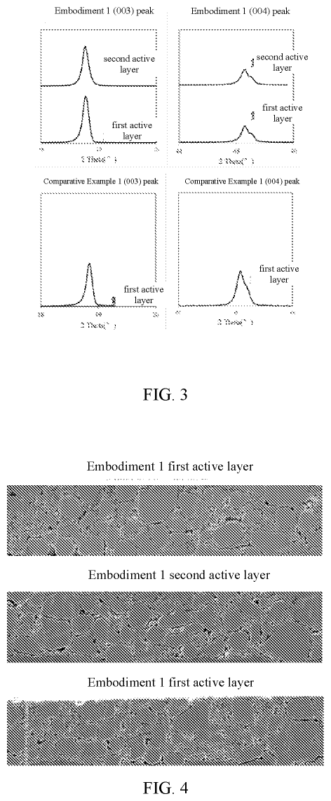

After 500 cycles, the batteries were disassembled to obtain Ia/Ib in the XRD patterns of the positive electrode plates. The results are recorded in Table 3. FIG. 2 shows an XRD pattern of the positive electrode plate after 500 cycles of the battery prepared in Embodiment 1, and FIG. 3 is a diagram of comparison between XRD patterns of the positive electrode plates after 500 cycles of the batteries prepared in Embodiment 1 and Comparative Example 1.

### (6) Particle Crushing Percentage Test

After 500 cycles, the batteries were disassembled, and the positive electrode first active layer and the positive electrode second active layer were tested with an argon ion beam cross-section polisher coupled with a scanning electron microscope (CP-SEM). The results are shown in Table 3. FIG. 4 shows SEM images of the first active layer and the second active layer of the positive electrode plate after 500 cycles of the battery prepared in Embodiment 1, as well as SEM images of the first active layer of the positive electrode plate after 500 cycles of the battery prepared in Comparative Example 1.

TABLE 2

| | Positive | Positive | | Positive |
|---|---|---|---|---|
| | electrode | electrode | | material loss |
| | potential V | impedance Ω | Energy | percentage |
| | after 500 | after 500 | density | after 500 |
| | cycles | cycles | Wh/L | cycles |
| Embodiment | 4.517 | 69 | 714.80 | 7.32 |
| 1 | | | | |
| Embodiment | 4.525 | 77 | 706.29 | 8.73 |
| 2 | | | | |
| Embodiment | 4.538 | 85 | 719.98 | 11.5 |
| 3 | | | | |
| Embodiment | 4.548 | 94 | 717.02 | 17.7 |
| 4 | | | | |
| Embodiment | 4.550 | 107 | 723.68 | 30.7 |
| 5 | | | | |
| Embodiment | 4.585 | 167 | 726.63 | 50.9 |
| 6 | | | | |
| Embodiment | 4.512 | 65 | 668.58 | 7.12% |
| 7 | | | | |
| Comparative | 4.570 | 120 | 723.68 | 40.8 |
| Example 1 | | | | |
| Comparative | 4.520 | 75 | 691.12 | 7.61 |
| Example 2 | | | | |
| Comparative | 4.549 | 104 | 723.68 | 28.7 |
| Example 3 | | | | |
| Comparative | 4.630 | 193 | 728.11 | 63.4 |
| Example 4 | | | | |
| Comparative | 4.612 | 187 | 720.35 | 58.7 |
| Example 5 | | | | |
| Comparative | 4.593 | 174 | 720.35 | 55.3 |
| Example 6 | | | | |

As can be seen from Table 2, as the battery prepared by using the positive electrode plate in the present disclosure is compared with that in Comparative Example 1, the positive electrode potential after 500 cycles, the positive electrode impedance after 500 cycles, and the positive material loss percentage after 500 cycles are all significantly reduced; as the battery prepared by using the positive electrode plate of the present disclosure is compared with that in Comparative Example 2, the energy density is significantly increased; the positive electrode plate of the present disclosure can effectively reduce the impedance on the premise of maintaining a relatively high energy density, further inhibit the positive active material from an irreversible phase transition, thereby reducing the energy loss of the positive active material; the battery prepared by using the positive electrode plate in Embodiment 5 shows little difference in the positive electrode potential after 500 cycles, the positive electrode impedance after 500 cycles, the energy density, and the positive material loss percentage after 500 cycles as compared with that in Comparative Example 3; however, the amount of carbon nanotubes added in Embodiment 5 is less, resulting in lower production costs of the battery in Embodiment 5, which is conducive to large-scale production of the battery; as can be learned from Embodiments 1-7 and Comparative Examples 1-6, the battery prepared by using the positive electrode plate in the present disclosure can achieve low positive electrode potential, low positive electrode impedance, high energy density, and low positive material loss rate after 500 cycles.

TABLE 3

| | Ia after | Ib after | | CPa after | CPb after | |
|---|---|---|---|---|---|---|
| | 500 | 500 | Ib/ | 500 | 500 | CPb/ |
| | cycles | cycles | Ia | cycles | cycles | CPa |
| Embodiment 1 | 2.58 | 2.57 | 0.996 | 5.3% | 5.7% | 1.08 |
| Embodiment 2 | 2.47 | 2.35 | 0.951 | 7.3% | 8% | 1.10 |
| Embodiment 3 | 2.13 | 1.97 | 0.925 | 12.5% | 15.6% | 1.25 |
| Embodiment 4 | 1.97 | 1.68 | 0.854 | 16.7% | 21.3% | 1.28 |
| Embodiment 5 | 1.78 | 1.34 | 0.753 | 36% | 59% | 1.63 |
| Embodiment 6 | 1.22 | 0.97 | 0.795 | 48% | 78% | 1.63 |
| Embodiment 7 | 2.90 | 2.74 | 0.945 | 5.0% | 5.2% | 1.04 |
| Comparative | 1.22 | / | / | 42% | / | / |
| Example 1 | | | | | | |
| Comparative | 2.51 | / | / | 8% | / | / |
| Example 2 | | | | | | |
| Comparative | 1.92 | / | / | 32% | / | / |
| Example 3 | | | | | | |
| Comparative | 0.97 | / | / | 54% | / | / |
| Example 4 | | | | | | |
| Comparative | 1.18 | 0.47 | 0.40 | 49% | 83% | 1.69 |
| Example 5 | | | | | | |
| Comparative | 1.89 | 0.52 | 0.28 | 38% | 79% | 2.07 |
| Example 6 | | | | | | |

As can be seen from Table 3, it can be learned from the comparison between Embodiments 1-7 and Comparative Examples 1-6 that after 500 cycles, Ib/Ia in Embodiments 1-7 falls within the range of 0.5<Ib/Ia≤1, indicating that the phase structure of the positive material is intact, which demonstrates that the energy loss of the positive active material can be effectively reduced, especially the energy loss in the cycling and float charging course under high temperature and high voltage can be significantly reduced; the CPb/CPa values all fall within the range of 1≤CPb/CPa≤2, indicating that the degree of the disruption to the positive material is low, which demonstrates that the energy loss of the positive active material can be effectively reduced.

1. A battery, wherein the battery comprises a positive electrode plate, the positive electrode plate comprises a positive current collector, a first active layer, and a second active layer, the first active layer is arranged on at least one side surface of the positive current collector, and the second active layer is arranged on an outer surface of the first active layer;
after the battery is charged to 4.48V at 1.5C and discharged at 0.7C at 45° C. for 500 cycles, a ratio Ia=I(003)/I(104) of a peak intensity (003) to a peak intensity (104) in an X-ray diffraction spectrum of the first active layer and a ratio Ib=I(003)/I(104) of a peak intensity (003) to a peak intensity (104) in an X-ray diffraction spectrum of the second active layer satisfy 0.5<Ib/Ia≤1.

2. The battery according to claim 1, wherein 1≤Ia≤3, and/or 0.5≤Ib≤3.

3. A battery, wherein the battery comprises a positive electrode plate, the positive electrode plate comprises a positive current collector, a first active layer, and a second active layer, the first active layer is arranged on at least one side surface of the positive current collector, and the second active layer is arranged on an outer surface of the first active layer;
after the battery is charged to 4.48V at 1.5C and discharged at 0.7C at 45° C. for 500 cycles, a particle crushing percentage CPa of the first active layer and a particle crushing percentage CPb of the second active layer satisfy 1≤CPb/CPa≤2.

4. The battery according to claim 3, wherein 5%≤CPa≤40%, and/or 5%≤CPb≤60%; and/or
the first active layer comprises a first active material, and the second active layer comprises a second active material; the first active material and the second active material are each independently at least one selected from lithium cobalt oxide, lithium nickel cobalt manganese oxide, lithium manganese oxide, lithium nickel manganese oxide, lithium nickel cobalt aluminum oxide, lithium nickel oxide, lithium nickel cobalt manganese aluminum oxide, and lithium iron phosphate.

5. The battery according to claim 1, wherein a ratio of the impedance of the first active layer to that of the second active layer is greater than or equal to 1.1;
preferably, the ratio of the impedance of the first active layer to that of the second active layer is 1.5-1000,
more preferably, the ratio of the impedance of the first active layer to that of the second active layer is 1.5-10.

6. The battery according to claim 1, wherein the first active layer further comprises a first conductive agent, and the second active layer further comprises a second conductive agent; based on the total weight of the first active layer, the first conductive agent has a content of 0.5-5% by weight; and/or; based on the total weight of the second active layer, the second conductive agent has a content of 1-40% by weight; and/or
the first conductive agent and the second conductive agent are each independently at least one selected from conductive carbon black, acetylene black, Ketjen black, conductive graphite, conductive carbon fiber, carbon nanotubes, metal powder, and carbon fiber.

7. The battery according to claim 6, wherein the second conductive agent comprises carbon nanotubes;
preferably, the mass of the carbon nanotubes accounts for 45%-65% of the total mass of the second conductive agent.

8. The battery according to claim 1, wherein a ratio of the thickness of the first active layer to that of the second active layer is (0.2-10):1; preferably, the ratio is (0.5-3):1.

9. The battery according to claim 1, wherein the first active layer has a thickness of 10-150 μm; and/or
the second active layer has a thickness of 10-150 μm.

10. The battery according to claim 1, wherein after the battery is charged to 4.48V at 1.5C and discharged at 0.7C at 45° C. for 500 cycles, a positive electrode potential is ≤4.550V; and/or
a positive electrode impedance is ≤107Ω.
